(19) United States
(12) Patent Application Publication
(10) Pub. No.: US 2004/0249855 A1
(43) Pub. Date: Dec. 9, 2004

(54) Method, apparatus, and computer program product for customized assistance to a user

(75) Inventors: Keely RaNae Detweiler, Austin, TX (US); Samuel Roy Detweiler, Austin, TX (US); Helen S. Hall, Austin, TX (US)

Correspondence Address: ANTHONY ENGLAND, PO Box 5307, AUSTIN, TX, 78763-5307, US

(73) Assignee: International Business Machines Corporation, Armonk, NY (US)

(21) Appl. No.: 10/455,171

(22) Filed: Jun. 5, 2003

(51) Int. Cl. G06F 7/00

(52) U.S. Cl. 707/104.1

(57) ABSTRACT

According to one form of the invention, a method for providing special needs services information to a customer includes receiving an identification of the customer by an enterprise. A universal database is then accessed. The universal database includes information identifying a special need of the customer. The database information for the customer is selectable responsive to the customer's identification. An enterprise database is also accessed that includes information identifying special needs services available from the enterprise. The customer is sent an indication of a set of special need related services that are-available from the enterprise for the customer. The set of services is determined by the enterprise database responsive to the customer's special need information.

### RELATED APPLICATION

This patent application is related to U.S. patent application Ser. No. 10/112,478, METHOD, APPARATUS, AND COMPUTER PROGRAM PRODUCT FOR AN ASSISTANCE TRANSPONDER, filed Mar. 28, 2002, and assigned to the assignee of the present application.

### BACKGROUND OF THE INVENTION

1. Field of the Invention

The present invention relates to methods, devices and computer program products for providing customized assistance to a user.

2. Related Art

Use of computer technology to assist persons with disabilities to improve their quality of life is well known. For example, a computer based navigational system equipped with a global positioning satellite (“GPS”) input provides assistance to a blind person to safely navigate from home to place of work.

Persons with mobility needs such as persons using a wheelchair generally have difficulty maneuvering around obstacles such as large doors or steps. Unfortunately, availability of assistance to maneuver around these obstacles may be limited due to a lack of information available to persons with mobility needs and/or a lack of communication between a requester and a provider of special service for persons with disabilities. Some solutions have resulted in the installation of automatic door openers and ramps at main entrances. However, the location of resources such as ramps and automatic doors is not always obvious, and such resources are generally of limited number. The same issues generally apply also with respect to resources for other special needs, such as, for example, persons with sight or hearing impairments. Therefore, a need exists to improve communication between a requester and a provider of special services for persons with disabilities.

### SUMMARY OF THE INVENTION

The foregoing need is addressed by the present invention. According to one form of the invention, a method for providing special needs services information to a customer includes receiving an identification of the customer by an enterprise. A universal database is then accessed. The universal database includes information identifying a special need of the customer. The database information for the customer is selectable responsive to the customer's identification. An enterprise database is also accessed that includes information identifying special needs services available from the enterprise. The customer is sent an indication of a set of special need related services that are available from the enterprise for the customer. The set of services is determined by the enterprise database responsive to the customer's special need information.

In another aspect, the customer's identification is received by the enterprise from an agent. The agent receives the customer identification and a location indicator for the customer, sends the customer's location indicator to an enterprise registry, and responsively receives access information for the enterprise from the registry. The registry determines the access information responsive to the customer location indicator. The agent then sends the customer's identification to the enterprise responsive to the enterprise access information.

Objects, advantages, additional aspects and other forms of the invention will become apparent upon reading the following detailed description and upon reference to the accompanying drawings.

### BRIEF DESCRIPTION OF THE DRAWINGS

FIG. 1 illustrates information flow for initializing certain databases, according to an embodiment of the present invention.

FIG. 2 illustrates information flow for accessing the databases and providing information to a customer, according to an embodiment of the present invention.

FIG. 3 illustrates a wireless communication device for use by a customer in communications shown in FIG. 2, according to an embodiment of the present invention.

FIG. 4 illustrates additional details of the device of FIG. 3, according to an embodiment of the present invention.

FIG. 5 illustrates a computer system that is generally applicable for various computer systems referred to herein, according to an embodiment of the present invention.

### DETAILED DESCRIPTION OF A PREFERRED EMBODIMENT

In the following detailed description of a preferred embodiment, reference is made to the accompanying drawings illustrating embodiments in which the invention may be practiced. It should be understood, however, that the drawings and detailed description are not intended to limit the invention to the particular form disclosed. On the contrary, the intention is to cover all modifications, equivalents and alternatives falling within the spirit and scope of the present invention as defined by the appended claims.

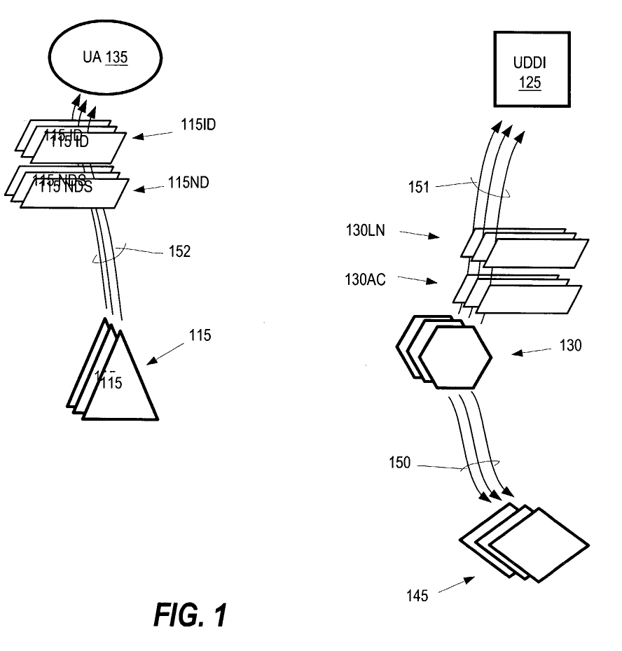

Referring now to FIG. 1, initialization steps are illustrated, according to an embodiment of the invention. Persons 115 with disabilities initially send respective identifiers 115ID and information 115ND about their respective needs to a universal access (“UA”) database 135 on one or more computer systems (not shown in FIG. 1). Likewise, enterprises, i.e., business facilities 130, such as shopping malls, initially send respective information 130LN regarding their locations and information 130AC regarding how to contact the enterprise to learn about their services and facilities for persons with special needs. This information is sent to a Universal Description, Discovery and Integration registry (“UDDI”) 125, a central repository of information on a computer system (not shown) about how to contact facilities 130 that provide services to disabled persons in connection with their business operations. Each of the facilities 130 also initializes and maintains their own respective databases 145 delineating their services and facilities for persons with special needs.

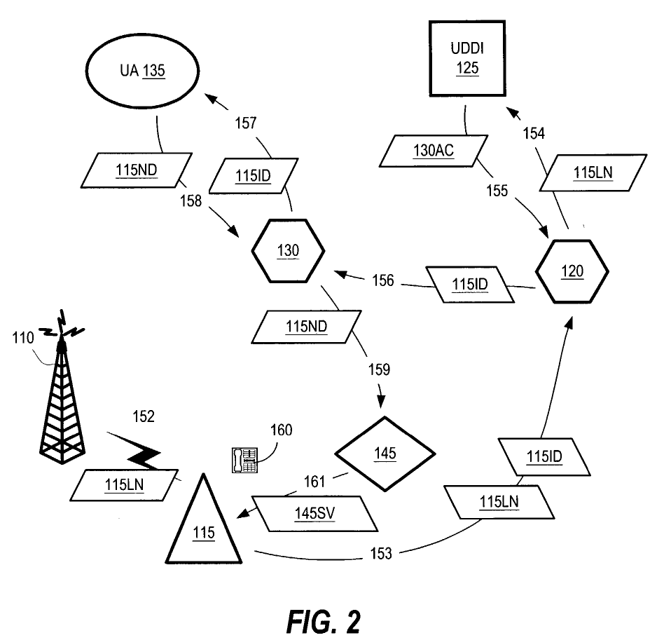

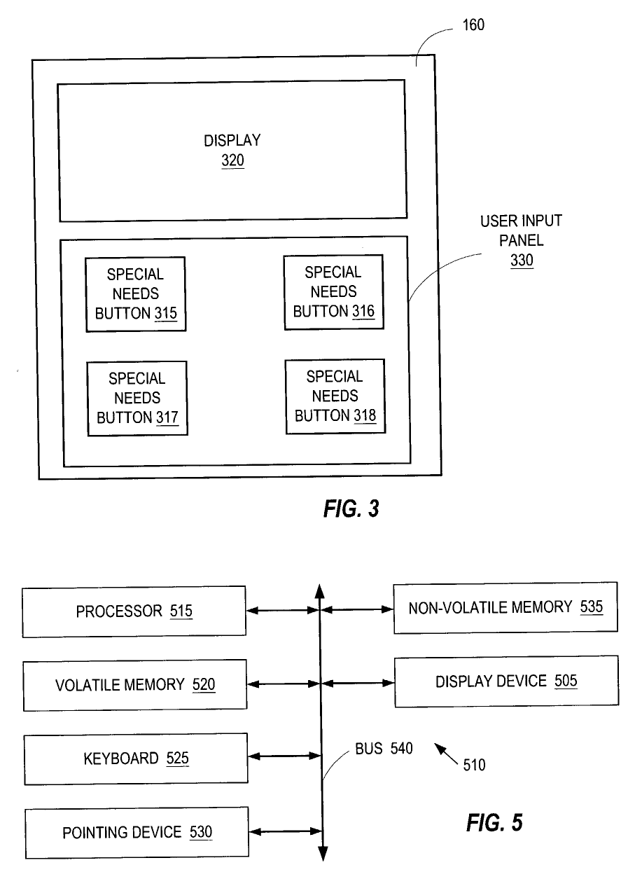

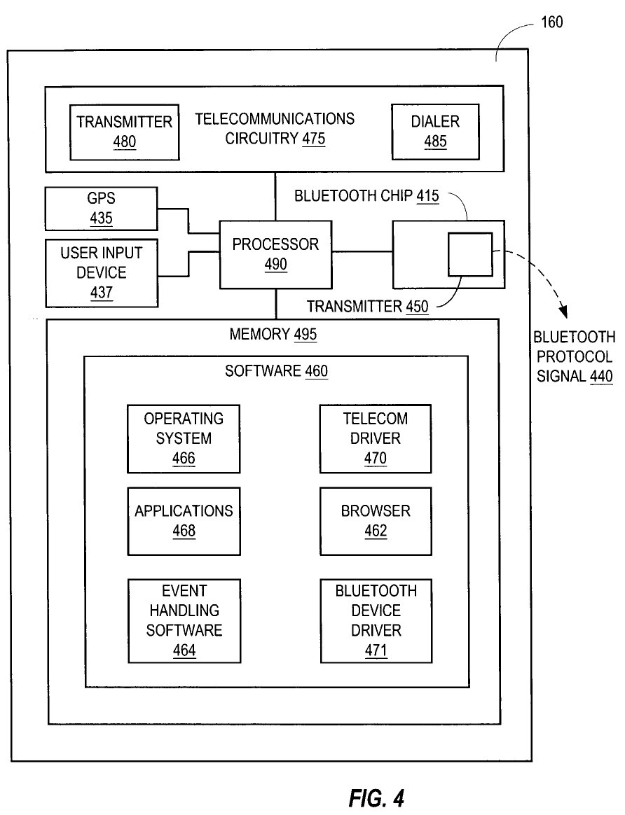

Referring now to FIG. 2, a disabled person (“requester”) 115 going to a business facility 130, such as a shopping mall, has a special need for which the facility 130 may provide assistance in order to better serve its customers. For example, requester 115 has a mobility impairment and needs to know where in the facility 130, e.g., shopping mall parking lot, there is a handicapped space with a wheelchair ramp on the right side. According to an embodiment of the invention illustrated in FIG. 2, the requester has a wireless device 160, which will be described further in FIGS. 3 and 4, and which in the present embodiment of the invention includes a cell phone. The device 160 has been programmed to store an identifier 1151D for the requester. This identifier 115ID was previously stored by the requester 115 in a universal access (“UA”) database 135, in the initialization process illustrated in previous FIG. 1, along with associated information 115ND about the nature of the special needs of the requester 115. The device 160 is also programmed with the phone number of a universal agent 120 for accessing the UA database 135. (for example something similar to 311, or 911, as a general purpose, non-location specific, number)

When the requester 115 is near or even inside the mall parking lot 130, the requester 115 signals the agent 120 using the cell telephone 160. In the signal to the agent 120, requester's phone sends 153 the requester's identification 115ID. Also, the requester's request 153 contains 152 a location indicator 115LN specific to the location of the requester's phone at the particular location from which the requester 115 is signaling, e.g., near the mall 130.

In an alternative embodiment, the location indicator 115LN has location information that is more specific to the location of the requester's phone 160, rather than merely being specific to the cell tower 110 location. For example, in one embodiment of the invention the location is indicated and the location indicator 115LN is provided by global positioning apparatus (not shown in FIG. 2) included in phone 160. In another embodiment, the location is specific to the requester's phone 160, but is indicated and the location indicator 115LN is provided by apparatus (not shown in FIG. 2) associated with the cell tower 110, and possibly also associated with one or more other cell towers (not shown in FIG. 2) in the device 160 cell phone provider's network.

To summarize the above, requester 115 has, at this point in the process of the embodiment, pushed a button on requester's device 160. This has resulted in the device 160 sending information 115ID and 115LN to the universal agent 120 identifying who is the requester 115 and where is the requester's location. Now the agent 120, or more specifically, a computer system (not shown in FIG. 2) of the agent 120, has two pieces of data that are helpful, but which are insufficient. The computer system of agent 120 (e.g., agent's) has to use those two pieces of information to return information that will help the requester 115.

Advantageously, in the above described embodiment of the invention, one or more operators have, in an initialization process described in connection with the previous FIG. 1, provided access identifiers 130AC and location information 130LN (FIG. 1) for a number of facilities 130, such as a parking lot, the common area within a mall, and the stores within that mall. The computer system of the agent 120 uses one of these identifiers 130AC to contact a computer system (not shown in FIG. 2) of the respective facility 130. In order to get the information that requester 115 needs, the agent 120 forwards 154 requester's identification 115ID to the UDDI 125, which matches the requester's location 115LN to one or more facility locations 130LN (FIG. 1), and returns 155 to the agent 120 facility access identifier(s) 130AC associated with the facility location(s) 130LN. In one embodiment, such an access identifier 130AC includes an Internet protocol (“IP”) address. In another embodiment, the access identifier 130AC merely includes a telephone number, so that a live person or voice or telephone key actuated recorded message system may respond to the requester 115 by audio telephone communication. In another embodiment of the invention, the access identifier 130AC includes a map of a facility, which the requesting device 160 is capable of displaying.

In the example above, the agent 120 can only narrow its response down to identification of a number of different nearby facilities 130, i.e., the parking lot, mall and mall stores, in response to the requester's location that was included in the request. Since the agent 120 cannot determine a single facility 130 that is certain to be responsive to the requester's needs, the agent 120 returns to the requester the identity, including access information 130AC, of all the nearby facilities 130 so that the requester may select which facility 130 to contact. The requester sends the selection to the agent 120.

Alternatively, the UDDI 125 may identify a second “agent” (not shown in FIG. 2) proximate to the indicated requester's location 115LN, instead of sending the first agent 120 the access information 130AC of all the nearby facilities 130 themselves. That is, responsive to the query by the first agent 120, the UDDI 125 merely returns an indication that additional requester 115 selections are in order before returning information for a particular facility 130. This indication includes information for three “agents,” i.e., for the parking lot, the common area of the mall and the stores. Then the requester 115 picks one of these three agents, such as, for example, the “agent” for the stores. In one embodiment of the invention, the requester 115 actually continues communicating with the original agent 120, and sends the selection of the store “agent” back to the agent 120. That is, agent 120 merely appears as three additional “agents” to the requester 115. In another embodiment of the invention, one or more of the three agents may actually be different processes than the original agent 120 and may even be at different locations, in which case the requester 115 selection may actually be sent to a second agent 120 (shown in dashed lines in FIG. 2). In either case, the description below refers to a second agent 120, but it should be understood that the subsequent communication with a second “agent” may actually be with only the one agent 120.

In the example, the selected second agent 120 gets information from the UDDI 125 for how to contact the individual stores, including facility access identifiers 130AC, and returns to the requester a list of the stores. The UDDI 125 could have supplied all this info about the stores to the first agent 120 instead of telling the first agent 120 to contact the second agent 120 for the list of contact information for the stores. But this way the number of choices presented at once to the requester 115 is reduced to a more manageable number.

Next, the requester 115 communicates a store selection to the second agent 120. A store is an example of a facility 130 in FIG. 2. Now that the agent 120 knows the correct facility access identifier 130AC, the agent 120 uses the identifier 130AC to send 156 the requester identifier 115ID to the facility 130, or more specifically, to a computer system (not shown in FIG. 2) of the facility 130. The facility 130 system in turn sends 157 the requester identifier 115ID to a UA database 135.

In an embodiment of the invention, the same UA database 135 serves a city or some such relatively localized geographical region, and may be reached anywhere in that region with one phone number. In another embodiment, the UA database 135 serves a larger area, such as a state or entire country with a single phone number, which may be toll free. In another embodiment, there may be numerous UA databases 135 in a relatively small geographic region, and the system of the facility 130 may be directed to the correct UA database 135 responsive to the location of the facility. Alternatively, the system of the facility 130 may be directed to the correct UA database 135 responsive the requester identifier 115ID. That is, the requester identifier 115ID may include information not only identifying the requester 115, but also identifying a specific one of the UA databases 135 (numerous ones of which were shown in FIG. 1), and how to contact the correct one.

In an embodiment of the invention, the UA information is distributed instead of residing in a large database 135. That is, each requester has their own special needs information 115ND stored in their own phone, for example, and the agent 120 returns the access identifier 130AC for the facility 130 to the requester 115 instead of sending the requester identifier 115ID to the facility. Then the requester may send the special needs info 115ND to the facility 130.

The UA database 135 searches its records to match the requester identifier 115ID received from the facility 130 with associated special needs information 115ND earlier received by requester 115 (described in connection with FIG. 1). Then, responsive to finding a match for the requester identifier 1151D, the UA database 135 sends 158 the matching special needs information 115ND back to the facility 130.

The facility sends 159 the special needs information 115ND to its own computer system (not shown in FIG. 2) for comparison to an enterprise database 145 of services and facilities accessible by that system. In response, the facility 130 system maps information in the database 145 to the particular needs identified in information 115ND, to generate specific information 145SV about particular services and facilities which facility 130 has that meet the identified needs 115ND. The facility 130 then sends 161 this information 145SV to the requester 115. That is, For example, if requester 115 has a mobility impairment and no hearing impairment, the specific information 145SV sent 161 does not include information about special telephone numbers for hearing impaired customers, since this telephone number information would be irrelevant to requester 115.

From the above description it should be appreciated that according to features of at least some of the above described embodiments, it is advantageous that the multitude of facilities that may exist in a region do not have to initialize and keep up to date a shared database with lots of details about each respective facility—e.g., for this facility there are seventeen doors, fifty seven handicapped parking spaces and four of them are ramp supported and one is on the East side of the building, etc., etc. Each facility merely provides contact information to the UDDI 125 and then keeps its own database. In this manner, the coordination effort required to implement the embodiment is greatly reduced. This ease of implementation is important to widespread adoption.

In an embodiment of the invention, the same universal agent 120 serves a city or some such relatively localized geographical region, and may be reached anywhere in that area with one phone number. In another embodiment, the agent serves a larger area, such as a state or entire country with a single phone number, which may be toll free. In another embodiment, there may be numerous agents in a relatively small geographic area, and the requester's device 160 may be directed to the correct agent responsive to the cell phone location at the time of the call. In one embodiment, this directing to the correct agent is done by apparatus (not shown in FIG. 2) in the cell phone provider's wireless carrier network. The term “wireless carrier network” refers to a cellular phone system, such as a system according to the GSM standard in the 900 MHz band, which is now pervasive in developed countries, and permits calling among both wired and cellular phones. It also includes a phone system of similar functionality, but of the satellite type, such as Globalstar. (Globalstar is a trademark of Loral QUALCOMM Satellite Services.)

The wireless carrier network includes the cell tower 110 and may include a short distance wireless communication mechanism such as Bluetooth or infrared. Bluetooth is a well-known technology standard using short-range radio links, and is intended to replace cable(s) connecting portable and/or fixed electronic devices. The Bluetooth standard, promulgated by the Bluetooth Special Interest Group (SIG), defines a uniform structure for a wide range of devices to communicate with each other. The Bluetooth technology also offers wireless access to local area networks (“LAN”), telephone networks, the mobile phone network, computer networks and the Internet. The Bluetooth wireless communication protocol uses the 2.4 gigahertz industrial, scientific, and medical band (“ISM band”) for close-range radio communication between various Bluetooth-enabled devices.

In related terminology, the term “close-range, standard-protocol network” is used herein to refer to a network formed by devices communicating at close-range, i.e., typically no more than 100 feet distant, using such a close-range, standard-protocol radio signal.

FIG. 3 illustrates a wireless device 160 equipped with at least one special needs button 315 according to an embodiment of the invention. Three additional special needs buttons 316-318 are illustrated according to an embodiment of the invention, each special needs button being configurable to request a particular special need of a person with disability. A display screen 320 is used to display text and/or graphic information. User input devices such as the special needs button 315 or keyboard, not shown, are grouped under a user input panel 330.

FIG. 4 shows more details of FIG. 3, and additional aspects of an embodiment of the invention. The wireless device 160 includes telecommunications circuitry 475 having a dialer 485, e.g., a multi-frequency tone generator, for dialing phone numbers. The circuitry 475 also has a transmitter 480 for sending voice and data signals. The circuitry 475 also has a receiver, not shown, for receiving messages. The circuitry 475 is coupled to a processor 490, and the processor 490 is coupled to a memory 495 in which software 460 is stored. The software 460 includes an operating system 466, various applications 468, a telecommunication circuitry driver 470 and a browser 462.

The software 460 includes event handling software 464, for detecting operation of one of the buttons 315-318 (FIG. 3) via user input device 437 coupled to processor 490. The wireless device 160 is operable to transmit a Bluetooth-protocol radio signal notification 440 of such an event responsive to the activation of one of the buttons 315-318 as follows. The wireless device 160 also includes a radio transmitter 450, which is part of a Bluetooth chip 415. Software 460 includes Bluetooth device drivers 471 for communicating between the processor 490 and the chip 415 to initiate the Bluetooth-protocol radio signal notification 440 by the radio transmitter 450 responsive to the activation of one of the buttons 315-318. The radio signal notification signal 440 may be received by other devices, e.g., a Bluetooth master device.

The wireless device 160 is capable of sending/receiving voice and/or data signals. Data may be displayed on the display screen 320 (FIG. 3) or through an audio device such as a speaker (not shown). The memory 495 is also operable for storing data such as personal information including passwords, names of assistance providers, telephone numbers, hours of operation for a business, e-mail addresses for routing a message via the signal 440 to a receiving device.

In the embodiment, the wireless device 160 also includes a GPS system 435 that automatically determines the position and/or location of the user. The position information may be communicated to a computer system by using the Bluetooth signal 440 or a signal via the telecommunication circuitry 475.

Referring now to FIG. 5, a computer system 510 is shown that is generally applicable for the various computer systems referred to herein. The system 510 includes a processor 515, a volatile memory 520, e.g., RAM, a keyboard 525, a pointing device 530, e.g., a mouse, a nonvolatile memory 535, e.g., ROM, hard disk, floppy disk, CD-ROM, and DVD, and a display device 505 having a display screen. Memory 520 and 535 are for storing program instructions which are executable by processor 515 to implement various embodiments of a method in accordance with the present invention. Components included in system 510 are interconnected by bus 540. A communications device (not shown) may also be connected to bus 540 to enable information exchange between system 510 and other devices. The communications device may include telecommunications circuitry or Bluetooth chip.

In various embodiments system 510 takes a variety of forms, including a personal computer system, mainframe computer system, workstation, client, server, Internet appliance, PDA, an embedded processor with memory, etc. That is, it should be understood that the term “computer system” is intended to encompass any device having a processor that executes instructions from a memory medium. Thus, the computer system 510 may be in the form of a wireless device, such as device 160 (FIG. 3).

The memory medium preferably stores instructions (also known as a “software program”) for implementing various embodiments of a method in accordance with the present invention. In various embodiments the one or more software programs are implemented in various ways, including procedure-based techniques, component-based techniques, and/or object-oriented techniques, among others. Specific examples include XML, C, C++, Java and Microsoft Foundation Classes (MFC).

The description of the present embodiment has been presented for purposes of illustration, but is not intended to be exhaustive or to limit the invention to the form disclosed. Many modifications and variations will be apparent to those of ordinary skill in the art. To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention. Those of ordinary skill in the art will appreciate that the hardware and methods illustrated herein may vary depending on the implementation. For example, it should be understood that while the Bluetooth wireless communications protocol is used for the short-range radio communications protocol of the present invention, it would be within the spirit and scope of the invention to encompass an embodiment using another protocol, such as IEEE 802.11. For example, the wireless device 160 of the described embodiment may be a cellular telephone or a personal digital assistant capable of communicating with other computers and/or telephones. Other devices, such multiple processors and memory devices and the like, may be used in addition to or in place of the hardware depicted. The depicted example is not meant to imply architectural limitations with respect to the present invention.

Additionally, it is important to note that while the present invention has been described in the context of a portable wireless device having a processor and memory, those of ordinary skill in the art will appreciate that the processes of the present invention are capable of being distributed as computer readable medium of instructions in a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

In another example, in other embodiments a message sent by the wireless device may be initiated by means other than a dedicated special needs button on the device. In one embodiment the message is initiated by a voice command. In another, a sequence of numbers on a keypad of the device is programed to initiate a message.

To reiterate, many additional aspects, modifications and variations are also contemplated and are intended to be encompassed within the scope of the following claims. Moreover, it should be understood that in the following claims actions are not necessarily performed in the particular sequence in which they are set out.

What is claimed is:

1. A method for providing, by an enterprise, special needs services information to a customer, the method comprising the steps of:
receiving an identification of the customer;
accessing a universal database, wherein the universal database includes information identifying a special need of the customer, the database information for the customer being selectable responsive to the customer's identification;
accessing an enterprise database, wherein the enterprise database includes information identifying special needs services available from the enterprise;
sending an indication to the customer of a set of special needs services available from the enterprise for the customer, wherein the set of services is determined by the enterprise database responsive to the customer's special need information.

2. The method of claim 1, wherein the customer's identification is received by the enterprise from an agent, and the method comprises the agent:
receiving the customer identification and a location indicator for the customer;
sending the customer's location indicator to an enterprise registry;
receiving from the registry information for accessing the enterprise, wherein the registry determines the access information responsive to the customer location indicator; and
sending the customer's identification to the enterprise responsive to the enterprise access information.

3. The method of claim 2, wherein the step of receiving access information for the enterprise from the registry includes receiving information identifying a number of entities, and wherein the method comprises the steps of:
sending the identity of the numerous entities to the customer; and
receiving a selection of the customer for one of the entities.

4. The method of claim 3, wherein the entities include enterprises.

5. The method of claim 3, wherein the entities include additional agents.

6. The method of claim 5, wherein the customer sends the selection to one of the additional agents.

7. The method of claim 1, wherein there are a number of universal databases and the step of accessing a universal database includes selecting one of the universal databases responsive to the customer's location indicator, the customer's identification or a location for the enterprise.

8. A computer program product for providing, by an enterprise, special needs services information to a customer, the computer program product comprising computer readable storage media, the storage media comprising:
instructions for receiving an identification of the customer;
instructions for accessing a universal database, wherein the universal database includes information identifying a special need of the customer, the database information for the customer being selectable responsive to the customer's identification;
instructions for accessing an enterprise database, wherein the enterprise database includes information identifying special needs services available from the enterprise;
instructions for providing an indication to the customer of a set of special needs services available from the enterprise for the customer, wherein the set of services is determined by the enterprise database responsive to the customer's special need information.

9. The computer program product of claim 8, wherein the customer's identification is received by the enterprise from an agent, and the computer program product comprises computer readable storage media for the agent, wherein the agent storage media comprises:
instructions for receiving the customer identification and a location indicator for the customer;
instructions for sending the customer's location indicator to an enterprise registry;
instructions for receiving from the registry information for accessing the enterprise, wherein the registry determines the access information responsive to the location indicator; and
instructions for sending the customer's identification to the enterprise responsive to the enterprise access information.

10. The computer program product of claim 9, wherein the instructions for receiving the enterprise access information from the registry include instructions for receiving information identifying a number of entities, and wherein the agent storage media comprises:
instructions for sending the identity of the numerous entities to the customer; and
instructions for receiving a selection of the customer for one of the entities.

11. The computer program product of claim 10, wherein the entities include enterprises.

12. The computer program product of claim 10, wherein the entities include additional agents.

13. The computer program product of claim 12, wherein the customer sends the selection to one of the additional agents.

14. The computer program product of claim 8, wherein there are a number of universal databases and the instructions for accessing a universal database includes instructions for selecting one of the universal databases responsive to the customer's location indicator, the customer's identification or a location for the enterprise.

15. An apparatus comprising:
a processor for an enterprise computer system;
a memory having instructions operable with the enterprise computer system processor for providing, by the enterprise, special needs services information to a customer, including performing the steps of:
receiving an identification of the customer;
accessing a universal database, wherein the universal database includes information identifying a special need of the customer, the database information for the customer being selectable responsive to the customer's identification;
accessing an enterprise database, wherein the enterprise database includes information identifying special needs services available from the enterprise;
sending an indication to the customer of a set of special needs services available from the enterprise for the customer, wherein the set of services is determined by the enterprise database responsive to the customer's special need information.

16. The apparatus of claim 15 comprising:
a processor for an agent computer system;
a memory having instructions operable with the agent computer system processor for providing, by the agent, special needs services information for the customer, including performing the steps of:
receiving the customer identification and a location indicator for the customer;
sending the customer's location indicator to an enterprise registry;
receiving from the registry information for accessing the enterprise, wherein the registry determines the access information responsive to the customer location indicator; and
sending the customer's identification to the enterprise responsive to the enterprise access information.

17. The apparatus of claim 16, wherein receiving the enterprise access information includes receiving information identifying a number of entities, and wherein the memory for the agent computer system including instructions operable with the agent computer system processor to perform the steps of:
sending the identity of the numerous entities to the customer; and
receiving a selection of the customer for one of the entities.

18. The apparatus of claim 17, wherein the entities include enterprises.

19. The apparatus of claim 17, wherein the entities include additional agents.

20. The apparatus of claim 19, wherein the customer sends the selection to one of the additional agents.

21. The apparatus of claim 15, wherein there are a number of universal databases and accessing a universal database includes selecting one of the universal databases responsive to the customer's location indicator, the customer's identification or a location for the enterprise.
